(19) United States
(12) Patent Application Publication
(10) Pub. No.: US 2018/0297243 A1
(43) Pub. Date: Oct. 18, 2018

(54) MULTIFUNCTION WIRELESS MOULD PRESSING HOT STAMPING BOARD

(71) Applicant: Hongping You, Yancheng (CN)

(72) Inventor: Hongping You, Yancheng (CN)

(21) Appl. No.: 15/485,240

(22) Filed: Apr. 12, 2017

(51) Int. Cl. B29C 35/02; B29C 59/02; B29C 59/00

(52) U.S. Cl. CPC B29C 35/0294; B29C 59/002; B29C 59/02

(57) ABSTRACT

This present invention relates to a DIY molding toy, particularly a kind of a self-made toy mold requiring embossing on the surface, wherein the double-roller mould pressing device and hot stamping device are set separately. The hot stamping device comprises thermal baffle, stamping heating panel and heating components, wherein the hot stamping heating panel is fixed on the surface of the thermal baffle and the heating components groups powered by an external plug-in power source are arranged in the interlayer of thermal baffle.

The hot stamping board can be separated from power source and kept heat continuously for a while to meet the temperature requirement for hot stamping, meanwhile the stamps are more obvious and uniform compared with the former devices. It can also be used for multiple devices to implement multiple functions of flash powder flocking, embossing indentation cutting, terrace and cavity die cutting hot stamping, and film covering.

### TECHNICAL FIELD OF THE INVENTION

The present invention relates to a DIY molding toy, particularly a kind of a self-made toy mold which requires embossing on the surface.

### BACKGROUND OF THE INVENTION

The existing DIY molding toy requires hot stamping during the molding process. The prior art provides a mould pressing hot stamping device which can not be matched with the existing mould pressing device. In the existing processing device, the mould passes between the two rollers while the mould pressing hot stamping device of the prior art is provided with a stationary heating board meanwhile a single roller passes over the heating board. That is to say, the motion track of mould pressing hot stamping device of the prior art is contrary to that of the existing mould pressing device. In addition, according to the prior art, multiple structure is adopted between the heating board and the roller because the roller has to pass over the heating board. Due to the multiple structure and its essential properties of plastic, the patterns will be not so uniform once an error is caused during pressing.

### SUMMARY OF THE INVENTION

In order to solve the problems above mentioned, the present invention provides a kind of multifunction wireless mould pressing hot stamping board which can be separated from the charging device so that the charging device can be used for the former old device.

In order to achieve the goals above, the present invention will be implemented as the following details, a kind of multifunction wireless mould pressing hot stamping board which is used cooperatively with a mould on the double-roller mould pressing device wherein the said mould is arranged on the hot stamping device and passes between the two rollers of the double-roller mould pressing device wherein the said double-roller mould pressing device and hot stamping device are set separately. The hot stamping device comprises thermal baffle, gold stamping heating panel and heating components groups, wherein the said hot stamping heating panel is fixed on the surface of the thermal baffle and the heating components groups powered by an external plug-in power source are arranged in the interlayer of thermal baffle.

Further, the said heating components groups comprise the heating panel, heat compensation power source, heat sensor and control circuit. The heating panel has two input terminals, one of which is connected with the output terminal of the said compensation power source while the other one is connected with the external plug-in power source. The input terminal of the said heat compensation is also connected with the external plug-in power source and the said heat sensor is connected with the edge of the hot stamping heating panel. The control circuit controls the input selection of the heating panel according to the temperature of the heat sensor.

Further, the said heat compensation power source is comprised of a controlled-release compensation capacitor.

Further, the said external plug-in power source comprises the external power source controller, the jack-plug and power source wires. The said jack-plug is a magnetic coupling coupled with the connecting joint of thermal baffle. The said external power source controller comprises a temperature receiver and a relay, wherein the said temperature receiver receives the temperature of the thermal baffle and controls the disconnection and connection of the relay. The power source wires are connected with the relay.

Further, the surfaces of the said thermal baffle and hot stamping heating panel are provided with the coordinate grid.

Further, the said thermal baffle is made from thermal insulation materials.

Further, the said external power source is provided with a temperature regulation button.

Further, the said moulds comprise of terrace die, cavity die and hot stamping foil. The surface of the said terrace die is provided with embossed patterns while the surface of the said cavity die is provided with intagliated patterns corresponding to the embossed patterns on terrace die surface. The said hot stamping foil is laid on the surface of terrace die and the object to be molded is arranged between the hot stamping foil and cavity die.

Further, the said shearing die of terrace die comprises the flat bearing plate and convex patterns provided with a flanging knife that fits the contours of the patterns.

In order to use and fix the mould, above the heating panel is provided with a stable thermal insulation cover plate jointed by hinge which can be used for heat preservation when heated by external power source and for fixing and pressing the mould under the cover plate to keep the position of the objects in mould unchanged during the process especially during the entrance of the mould into mould pressing device.

The technical effect of this present invention is that the hot stamping board can be separated from power source and kept heat continuously for a while to meet the temperature requirement for hot stamping, meanwhile the stamps are more obvious and uniform compared with the former devices and the stamping board can also be used for multiple equipments to implement the multiple functions of flash powder flocking, embossing indentation cutting, terrace and cavity die cutting hot stamping, and film covering.

### BRIEF DESCRIPTION OF THE DRAWINGS

FIG. 1 is the schematic diagram of the multifunction wireless mould pressing hot stamping board.

FIG. 2 is the schematic diagram of the back side of the multifunction wireless mould pressing hot stamping board.

FIG. 3 is the schematic diagram of the external plug-in power source.

FIG. 4 is the schematic diagram of the double-roller mould pressing device.

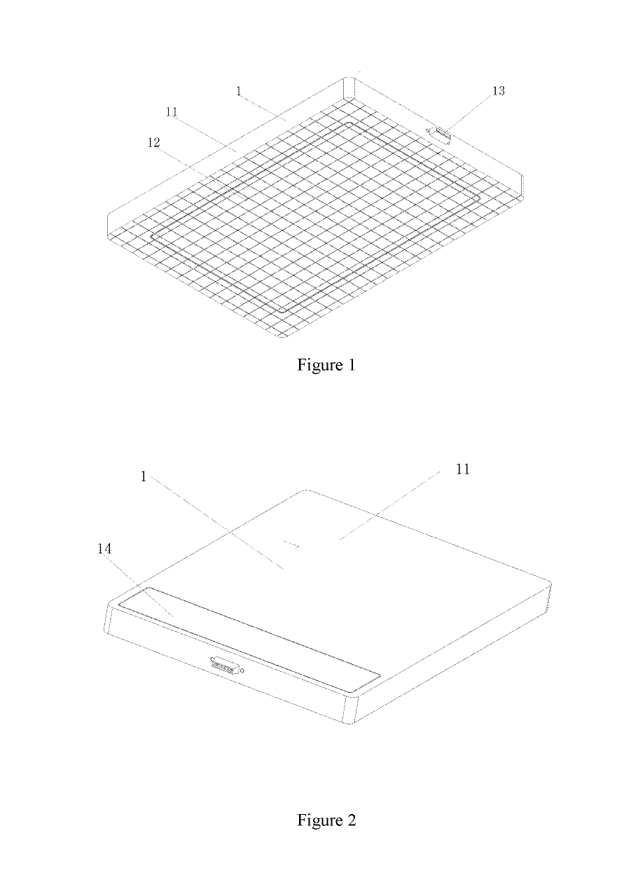

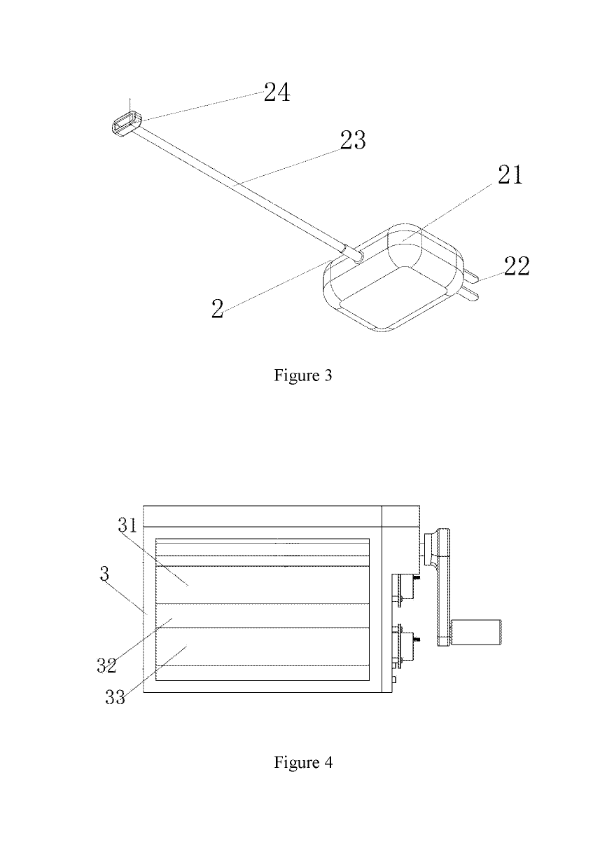

### DETAILED DESCRIPTION OF THE EMBODIMENTS

As shown in the figures, a kind of multifunction wireless mould pressing hot stamping board which is used cooperatively with a mould on the double-roller mould pressing device 3 wherein the said mould is arranged on the hot stamping device and passes the position 32 between the two rollers 31 and 32 of the double-roller mould pressing device 3 wherein the said double-roller mould pressing device 3 and hot stamping device 1 are set separately. The hot stamping device 1 comprises thermal baffle 11, gold stamping heating panel 12 and heating components groups, wherein the surfaces of the said thermal baffle 11 and hot stamping heating panel 12 are provided with the coordinate grid. The thermal baffle 11 is made from the the heat preservation materials.

The said hot stamping heating panel 12 is fixed on the surface of the thermal baffle 11 and the heating components groups powered by an external plug-in power source are arranged in the interlayer of thermal baffle.

The said heating components groups comprise the heating panel, heat compensation power source 14, heat sensor and control circuit. The heating panel has two input terminals, one of which is connected with the output terminal of the said compensation power source 14 while the other one is connected with the external plug-in power source. The input terminal of the said heat compensation 14 is also connected with the external plug-in power source and the said heat sensor is connected with the edge of the hot stamping heating panel 12. The control circuit controls the input selection of the heating panel according to the temperature of the heat sensor.

The said external plug-in power source 2 comprises the external power source controller 21, the attaching plug 22, the jack-plug 24 and power source wires 23. The said jack-plug is a magnetic coupling coupled with the connecting joint 13 of thermal baffle 11. The said external power source controller comprises a temperature receiver and a relay, wherein the said temperature receiver receives the temperature of the thermal baffle and controls the disconnection and connection of the relay. The power source wires are connected with the relay.

The said moulds comprise of terrace die, cavity die and hot stamping foil. The surface of the said terrace die is provided with embossed patterns while the surface of the said cavity die is provided with intagliated patterns corresponding to the embossed patterns on terrace die surface. The said hot stamping foil is laid on the surface of terrace die and the object to be molded is arranged between the hot stamping foil and cavity die.

The said shearing die of terrace die comprises the flat bearing plate and convex patterns provided with a flanging knife that fits the contours of the patterns.

In the above technical solutions, the said heat compensation power source 14 is comprised of a controlled-release compensation capacitor.

In order to use and fix the mould, above the heating panel is provided with a stable thermal insulation cover plate jointed by hinge which can be used for heat preservation when heated by external power source and for fixing and pressing the mould under the cover plate to keep the position of the objects in mould unchanged during the process especially during the entrance of the mould into mould pressing device.

When in usage of processing the papers, firstly power on the hot stamping device, heat the heating components groups and charge the heat compensation power source 14 at the same time. When the heat reaches the setting temperature, the heating should be ceased. At this time, place the mould and other components according to the requirements of the prior art, then let the mould together with the hot stamping board pass between the two rollers. There might be heat loss due to the cease of heating, so that the heat compensation power source 14 will began to output to carry out the thermal compensation. In order to be convenient for heating and charging, an improvement of connecting joint is also made to adopt the magnetic connection meanwhile a coordinate grid is provided on the surface of the boards and panels for the convenient placing of the objects to be molded. Besides the hot stamping and mould pressing, the present invention can also be applied for flash powder flocking, embossing indentation cutting, terrace and cavity die cutting hot stamping, and film covering.

1. A kind of multifunction wireless mould pressing hot stamping board use cooperatively with a mould on the double-roller mould pressing device wherein the said mould is arranged on the hot stamping device and passes between the rollers of the double-roller mould pressing device wherein the said double-roller mould pressing device and hot stamping device are set separately. The hot stamping device comprises thermal baffle, gold stamping heating panel and heating components, wherein the said hot stamping heating panel is fixed on the surface of the thermal baffle and the heating components groups powered by an external plug-in power source are arranged in the interlayer of thermal baffle.

2. A kind of multifunction wireless mould pressing hot stamping board of claim 1, wherein the said heating components comprise the heating panel, heat compensation power source, heat sensor and control circuit. The heating panel has two input terminals, one of which is connected with the output terminal of the said compensation power source while the other one is connected with the external plug-in power source. The input terminal of the said heat compensation is also connected with the external plug-in power source and the said heat sensor is connected with the edge of the hot stamping heating panel. The control circuit controls the input selection of the heating panel according to the temperature of the heat sensor.

3. A kind of multifunction wireless mould pressing hot stamping board of claim 2, wherein the said heat compensation power source is comprised of a controlled-release compensation capacitor.

4. A kind of multifunction wireless mould pressing hot stamping board of claim 1, wherein the said external plug-in power source comprises the external power source controller, the jack-plug and power source wires. The said plug is a magnetic coupling coupled with the connecting joint of thermal baffle. The said external power source controller comprises a temperature receiver and a relay, wherein the said temperature receiver receives the temperature of the thermal baffle and controls the disconnection and connection of the relay. The power source wires are connected with the relay.

5. A kind of multifunction wireless mould pressing hot stamping board of claim 1, wherein the surfaces of the said thermal baffle and hot stamping heating panel are provided with the coordinate grid.

6. A kind of multifunction wireless mould pressing hot stamping board of claim 1, wherein the said thermal baffle is made from thermal insulation materials.

7. A kind of multifunction wireless mould pressing hot stamping board of claim 4, wherein the said external power source is provided with a temperature regulation button.

8. A kind of multifunction wireless mould pressing hot stamping board of claim 1, wherein the said moulds comprise of terrace die, cavity die and hot stamping foil. The surface of the said terrace die is provided with embossed patterns while the surface of the said cavity die is provided with intagliated patterns corresponding to the embossed patterns on terrace die surface. The said hot stamping foil is laid on the surface of terrace die and the object to be molded is arranged between the hot stamping foil and cavity die.

9. A kind of multifunction wireless mould pressing hot stamping board of claim 8, wherein the said shearing die of terrace die comprises the flat bearing plate and convex patterns provided with a flanging knife that fits the contours of the patterns.

10. A kind of multifunction wireless mould pressing hot stamping board of claim 1, wherein the surface of the said thermal baffle is provided with a stable thermal insulation cover plate jointed by hinge whose size is well matched with the size of hot stamping heating panel.
